(19) United States
(12) Patent Application Publication
(10) Pub. No.: US 2007/0058608 A1
(43) Pub. Date: Mar. 15, 2007

(54) Telephone network architecture for a voice over internet protocol service

(75) Inventor: Shiejye Geoffrey Lin, Duluth, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation, Wilmington, DE (US)

(21) Appl. No.: 11/222,526

(22) Filed: Sep. 9, 2005

(51) Int. Cl. H04L 12/66

(52) U.S. Cl. 370/352; 370/401

(57) ABSTRACT

A VoIP telephone network system for providing VoIP telephone service to telephone customers connected to the network, has a managed IP network; a plurality of gateways connected to the managed IP network; a plurality of telephones connected to the gateways; a VoIP server connected to the managed IP network; a SIP server connected to the managed IP network; and each of the gateways has a gateway processor wherein the gateway processor converses with the SIP server to establish a telephone call through the managed IP network from a gateway connected to a telephone customer at a source location to a gateway connected to a telephone customer at a destination location. Further, the gateway processor also converts between analog voice signals and VoIP data packets whereby the voice-to-VoIP conversion is decoupled from the customer location.

### FIELD OF THE INVENTION

This invention relates to a new architecture for a telephone network implementing a voice over internet protocol (VOIP) service for a telephone.

### BACKGROUND OF THE INVENTION

To date a VoIP (voice over internet protocol) service has been provided to telephone customers through an analog telephone adapter and a DSL modem at the customer's home or office. The twisted pair telephone line from the customer's location carried voice, if the customer had a regular telephone service as well, plus it carried data if the customer had a personal computer and VoIP service. Data packets passed over the twisted paper telephone lines to a DSLAM (DSL aggregate multiplexer) at a telephone company facility. At this DSLAM the conventional voice signal was separated from the data and VoIP signals by a low pass filter. A high pass filter passed the data and VoIP signals to a CODEC (coder/decoder) that converted these signals into data packets. The data packets were sent to an internet service provider and onto the internet.

Problems with this prior art VoIP telephone network configuration include complexity and reliability. From the standpoint of complexity, the customer's location requires an analog telephone adapter, a modem, and the customer must have DSL service. Regarding reliability, the customer's equipment is AC powered. Accordingly, if there is a power failure, the analog telephone adapter and the modem providing the VoIP service at the customer location goes down and VoIP service is no longer available to the customer.

What is needed is a telephone network architecture that would support VoIP service without requiring VoIP equipment at the customer's location or any AC-powered equipment at the customer's location.

### SUMMARY OF THE INVENTION

In accordance with this invention, the above and other problems have been addressed by providing a gateway at the telephone company facility serving customer locations. The gateway establishes a VoIP telephone service connection from a source location of a calling party to a destination location of a called party. The telephone network has telephone lines between a gateway and a source or destination location and has an internet protocol (IP) network connected between gateways. A SIP server and a VoIP server are connected to the internet protocol network. The gateway has a SIP signaling module and a voice-to-VoIP processing module. The SIP signaling module works with the SIP server to initiate a communication session over the internet protocol network between a source location and a destination location. The voice-to-VoIP processing module codes and decodes between analog voice and VoIP data packets. The analog voice signal is received and sent over telephone lines, and the data packets are sent and received over the internet protocol network.

In another aspect of the invention, a VoIP telephone network system for providing VoIP telephone service to telephone customers connected to the network, has a managed IP network; a plurality of gateways connected to the managed IP network; a plurality of telephones connected to the gateways; a VoIP server connected to the managed IP network; a SIP server connected to the managed IP network; and each of the gateways having a gateway, or voice gateway, processor wherein the gateway processor converses with the SIP server to establish a telephone call through the managed IP network from a gateway connected to a telephone customer at a source location to a gateway connected to a telephone customer at a destination location. Further, the gateway processor also converts between analog voice signals and VoIP data whereby the VoIP conversion is decoupled from the customer location.

These and various other features as well as advantages, which characterize the present invention, will be apparent from a reading of the following detailed description and a review of the associated drawings.

### BRIEF DESCRIPTION OF THE DRAWINGS

FIG. 1 illustrates the conventional architecture for implementing voice over internet protocol service using an analog telephone adapter and modem at the customer's location.

FIG. 2 illustrates a preferred embodiment of the architecture implementing the invention whereby the voice is passed from the customer's location to a voice gateway in the telephone network and the voice gateway communicates with various servers at the gateway or in the telephone company IP network to provide the VoIP service.

FIG. 3 shows a preferred embodiment of the voice gateway in the DSLAM with Gateway 202 of FIG. 2.

FIG. 4 illustrates the flow of operations performed by the voice gateway, the SIP server, and the softswitch in FIG. 2 when a customer is placing a call to a destination within a PSTN (Public Switched Telephone Network) using the VoIP service.

FIG. 5 shows the flow of operations performed by the voice gateway, the SIP server, and the softswitch in FIG. 2 when the customer is receiving a telephone call from a source within a PSTN.

### DETAILED DESCRIPTION OF PREFERRED EMBODIMENTS

In the preferred embodiments of the invention, a gateway is provided at the telephone company facility collecting voice communication lines from the customer locations. The gateway communicates through a telephone company managed IP network to a plurality of servers. More particularly, a softswitch handles SIP signaling for routing of calls to and from the PSTN, a VoIP server handles processing of VoIP data packets, and a SIP server handles initiation of a communication session for the VoIP service. The gateway works with the SIP server to establish a call connection. The gateway works with the VoIP server to provide VoIP features and to code and decode the voice signal from the customer into data packets.

The voice gateway might be placed in any number of telephone network edge devices serving as a collection point for voice lines to the customers' locations. Some of these edge devices include a DSLAM where DSL service is also being provided to the customers. Other telephony edge devices might be a line gateway card, where there is only voice service, and edge devices in an FITL (Fiber To Loop)—both analog and multiplex—, a DLC (Digital Loop Carrier) and other telephony or data systems.

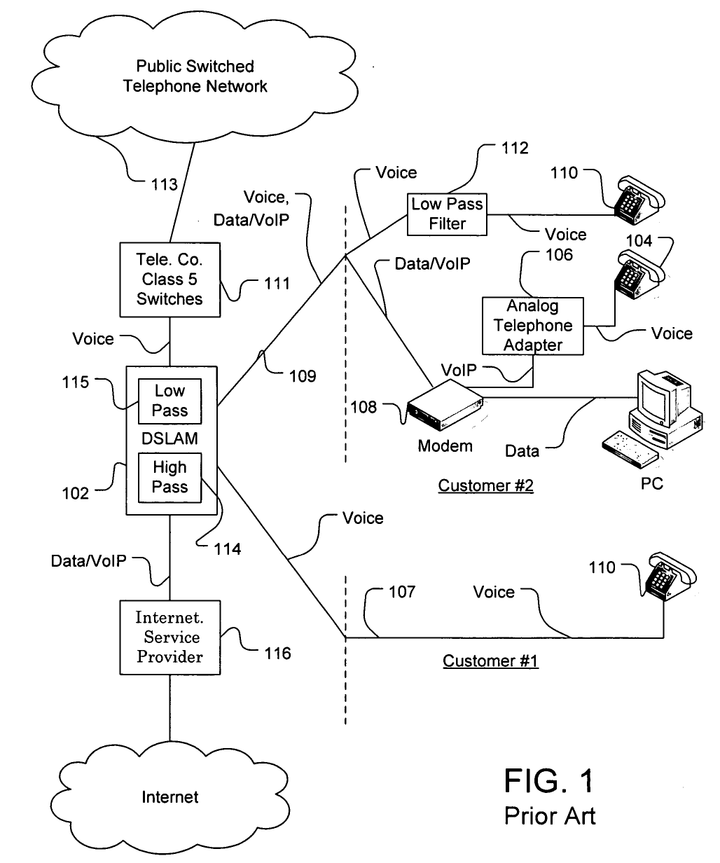

FIG. 1 illustrates a typical telephone network system providing DSL service and VoIP service to customers prior to the present invention. This network utilizes a DSLAM (Digital Subscriber Line Access Multiplexer) 102 that receives twisted pair lines from the customer's location. Two customer locations are illustrated. Customer No. 1 has simply a voice service provided by the telephone company, while Customer No. 2 has a voice service but in addition has DSL service. Further, Customer No. 2 is using a VoIP service with the DSL service.

To provide the VoIP service, a telephone 104 is connected to an analog telephone adapter 106 that converts the voice into digital data packets. The digital data packets are modulated on a high frequency signal by modem 108 and passed over a twisted pair line 109 to the DSLAM 102. Modem 108 also modulates data packets from a personal computer and passes that data over twisted pair line 109 to the DSLAM 102. At the same time, at the lower frequency which contains a voice signal, voice from a POTS phone 110′ is passed over twisted pair line 109 to the DSLAM. Low pass filter 112 filters out the higher frequencies being used by modem 108.

Customer No. 1 has only voice service, and the voice signal is passed over the twisted pair line 107 to the DSLAM 102. At the DSLAM 102 the voice signal is separated by a low pass filter 115 and passed to switches 111, such as the telephone company class five switches. The voice signal is passed through a Public Switched Telephone Network 113 in the conventional manner. The data and VoIP high frequency signal is passed by the high pass filter 114 to a CODEC (not show). The CODEC converts the signal to data packets and sends the data packets to an internet service provider 116 to provide Customer No. 2's internet service. The data packets are placed onto the internet by the internet service provider 116.

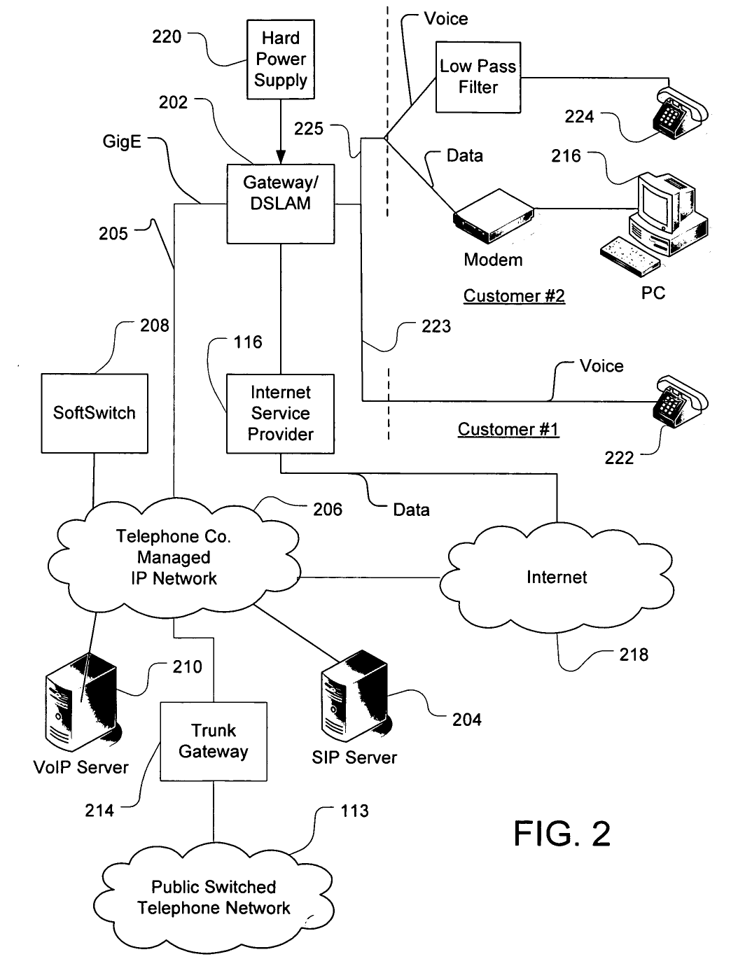

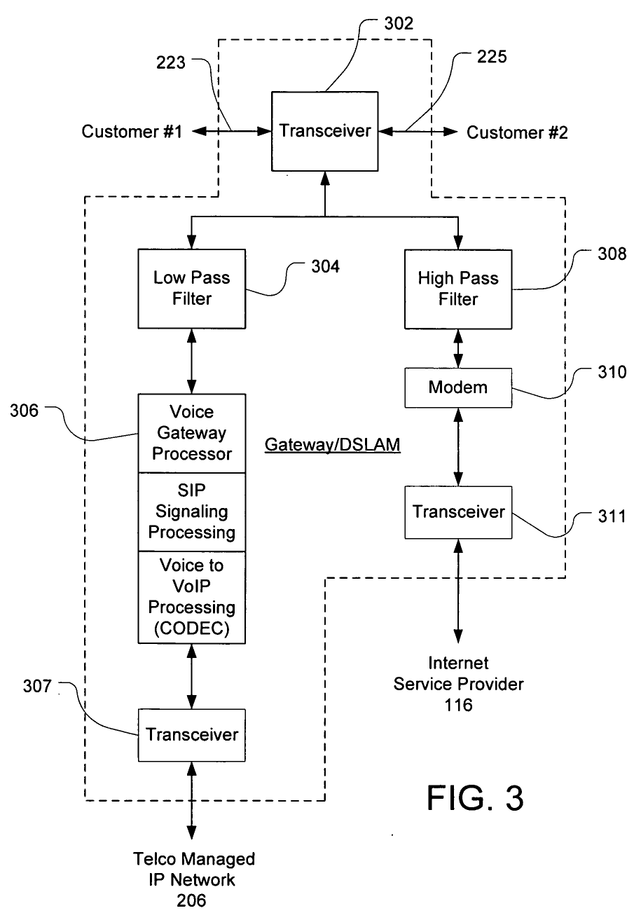

FIG. 2 shows a preferred embodiment of the invention where the same two customers of FIG. 1 are now connected to a Gateway/DSLAM 202. The Gateway/DSLAM 202 has a gateway, or voice gateway, processor (306, FIG. 3) that converses with a SIP server 204 to establish a call connection. The communication to the SIP server 204 is through a high-speed Gigabit Ethernet (GigE) connection to a telephone company managed IP network 206. The SIP server 204 routes the call to the destination. Further, the voice gateway processor 306 in Gateway/DSLAM 202 communicates with a VoIP server 210 to provide VoIP features to the customer. If the other party in the call is communicating over the PSTN 113, then a softswitch 208 and a trunk gateway 214 provides an interface to the PSTN 113.

The voice gateway 202 and a trunk gateway 214 include voice-to-VoIP conversion, i.e. a CODEC. As a result, customers do not need an analog telephone adapter. In fact, the voice signal from the customers to the gateways 202 and 214 is an analog voice signal. The customers are thus insulated from the VoIP processing. On the other hand, the customers may take advantage of the VoIP services by either providing command codes via their telephone keypad or accessing the VoIP server 210 through a personal computer 216.

The intelligence for setting up a call connection and for providing VoIP features to the customer is located in the SIP Server 204 and the VoIP server 210. The VoIP server 210 processing can be located at the SIP server 204. The voice gateway processor 306 is simply an agent and does not exercise any call control over the SIP or VoIP processes. Further as depicted in FIG. 2, the softswitch 208 is located somewhere on the managed IP network 206.

To use VoIP features, Customer No. 2 with a personal computer 216 may use the personal computer 216 to access the VoIP server 210 either through the managed IP network 206 or through the internet 218 via the customer's internet service provider 116. Of course, the internet service provider 116 might be the same company providing the VoIP service, such as a telephone company, cable company, or other VoIP or communications provider. In the case of a Telco internet service provider, a connection exists between the Telco managed IP network 206 and the Telco internet service provider 116.

There are two great advantages of the embodiment in FIG. 2. First, the telephone customer has the use of the VoIP services and all the features that it can provide without the complexity of having to have a DSL service. Of course, if the customer does have DSL service, then there is additional ease of operation in controlling some of the VoIP features via the personal computer 216. The other great advantage relates to a hardened power supply 220 at the Gateway/DSLAM 202. The hardened power supply 220 provides DC power to the DSLAM and voice gateway 202, and the hardened power supply 220 has backup power such as a battery, a generator, or other backup power, to guarantee that if AC power fails, the Gateway/DSLAM 202 still has DC power. Further, the Gateway/DSLAM 202 provides the DC power to operate the phones 110 and 110′ through the telephone lines 225 to the customers. The telephone lines 225 are usually twisted pair lines. Therefore, the customers' phones will also remain functioning using VoIP service even if AC power fails at the customer's location.

FIG. 3 shows one preferred embodiment of the Gateway/DSLAM 2002 in FIG. 2. In FIG. 3 a transceiver 302 receives or sends signals over the telephone, or twisted pair, lines 223 and 225 to the customers of the telephone company. A customer may be a voice customer—customer #1, (FIG. 2)—or a voice/DSL customer—customer #2 (FIG. 2). In any case, the voice signal will be a lower frequency signal and will be passed by a low pass filter 304 to the voice gateway processor 306. The DSL data signal, on the other hand, will be passed by the high pass filter 308 to the modem 310. Modem 310 will demodulate the DSL signal, and transceiver 311 sends data packets to the customer's internet service provider. Alternatively if customer's internet service provider 116 is the telephone company, the data packets would be sent over the telephone company managed IP network 206 to the internet service provider server 116.

The voice gateway processor 306 is performing two processing sessions that operate in parallel. One processing session is SIP signaling, and the other processing session is the voice-to-VoIP processing or CODEC processing. CODEC processing (coding and decoding) converts signals between analog voice signals and VoIP data packets. Data packets from the voice gateway processor 306 are sent by transceiver 307 to the Telco managed IP network 206. The data packets may be routed through the internet 218 to their destination or through the Telco managed IP network 206 to their destination. If the destination is another Telco customer served by another Gateway/DSLAM 202, then the voice data packets will be routed to the Gateway/DSLAM 202 via managed IP network. Gateway/DSLAM 202 will convert the data packets back to analog voice. If the destination is in the PSTN 113, then the voice data packets will be routed to the trunk gateway 214 from the managed IP network 206. Trunk gateway 214 will convert the data packets back to analog voice before passing them into the PSTN 113.

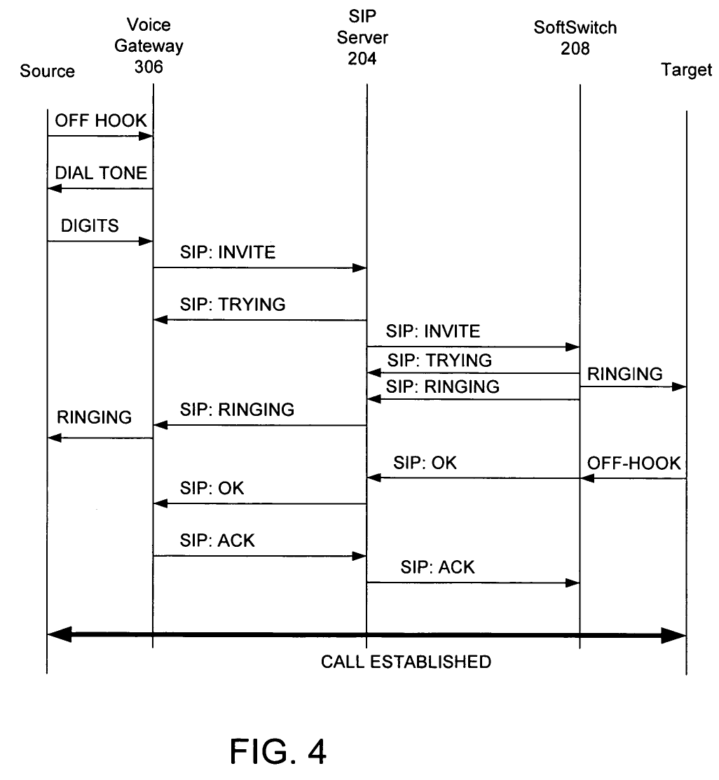

FIG. 4 illustrates one preferred embodiment for the call flow in the VoIP architecture network for a customer placing a call to a destination in the PSTN 113. The call flow sequence is from top to bottom in the figure. The source is the location of the calling party, and the target is the location of the called party. The first operation in the call flow is where the calling party goes off hook. In other words, the calling party picks up the phone to place a call. The voice gateway processor 306 sends a dial tone to the source through transceiver 302. The calling party then dials the digits identifying the destination for the call. When the voice gateway 306 receives the digits, it sends through transceiver 307 a session invite message to the SIP server 204. The SIP server 204 will return a “trying” message indicating the SIP server 204 is trying to make the connection. The SIP server 204 also then sends a session invite message to a softswitch 208. The softswitch 208 returns a “trying” message indicating it is trying to make the connection to the destination. The softswitch 208 sends the ringing signal to the destination and returns a ringing message to the SIP server 204. The SIP server 204 forwards the ringing message back to the voice gateway 306, and the voice gateway 306 sends a ringing signal back to the source. When the called party at the destination picks up the phone, an off-hook signal goes back to the softswitch 208, and the softswitch 208 sends an OK message to the SIP server 204. The SIP server 204 passes the OK message to the voice gateway 202. The voice gateway 202 acknowledges the OK message back to the SIP server 204, and the SIP server 204 passes the acknowledged message back to the softswitch 208. The call between the source and destination is now established.

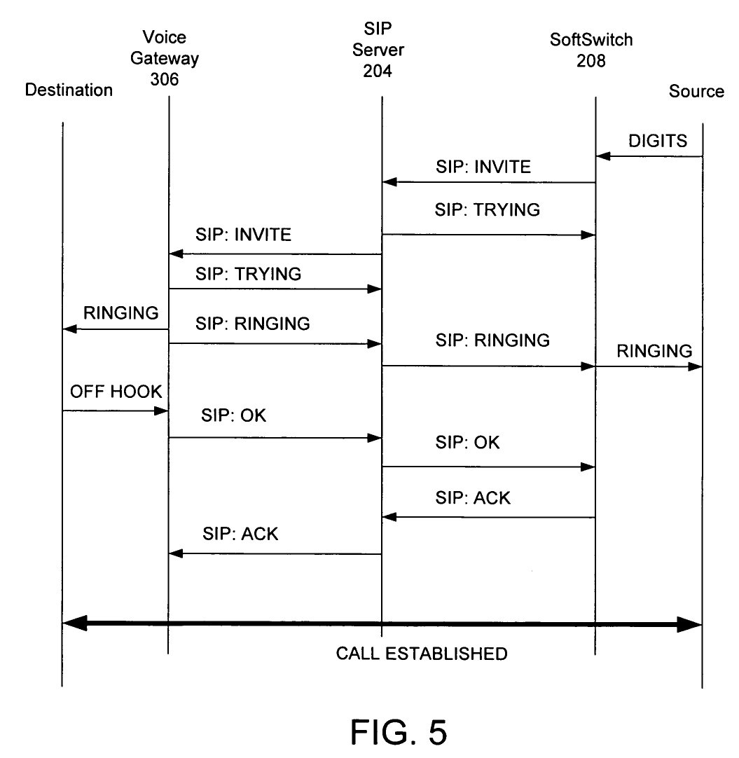

FIG. 5 shows a call flow diagram for a call coming from a source in the PSTN 113 to a telephone company customer having the VoIP service. In this case, the source, location of calling party, is at the right hand edge of the call flow diagram, and the destination, location of called party, is at the left hand edge of the call flow diagram in FIG. 5. The call flow begins when the source sends the telephone number digits to the softswitch 208 identifying a destination under the VoIP service. The softswitch 208 then sends a session invite message to the SIP server 204. The SIP server 204 returns a “trying” message back to the softswitch 208. The SIP server 204 at the same time sends a session invite message to the voice gateway 306. The voice gateway 306 returns a trying message back to the SIP server 204. The voice gateway 306 also sends a ringing signal over the telephone line to the destination location.

After the ringing signal is sent to the destination location, the voice gateway 306 returns a ringing message back to the SIP server 204, and the SIP server 204 passes on the ringing message to the softswitch 208. The softswitch 208 sends a ringing signal back to the source for each ringing message it receives. When the called party picks up the phone at the destination, an off-hook signal goes to the voice gateway 306. The voice gateway 306 sends an OK message back to the SIP server 204. The SIP

1. A gateway in a telephone network for establishing a VoIP telephone service connection from a source location of a calling party to a destination location of a called party, the telephone network having telephone lines between the gateway and a source or destination location and having an internet protocol network connected between gateways, and having a SIP server and a VoIP server connected to the internet protocol network, said gateway comprising:
a SIP signaling module working with the SIP server over the internet protocol network to initiate a communication session between a source location and a destination location; and
a voice-to-VoIP processing module coding and decoding between analog voice and VoIP data, the analog voice signal being received and sent over telephone lines and the data being sent and received over the internet protocol network.

2. The gateway of claim 1 wherein the internet protocol network is managed by a telephone company and at least one of the source and destination locations is a telephone company customer.

3. The gateway of claim 2 wherein the telephone company customer is also a DSL customer of the telephone company, the telephone line carries a data signal modulated on a frequency outside voice frequency range, and the gateway further comprises:
a DSL modem modulating and demodulating to convert between data signals and modulated data signals.

4. The gateway of claim 2 further comprising:
a DC power supply with power supply back up to guarantee DC power to the gateway and to the telephone customers over the telephone lines.

5. The gateway of claim 1 is located in a telephony edge device at the edge between a telephone line to a telephone company customer and a telephony carrier system of the telephone company.

6. A VoIP telephone network system for providing VoIP telephone service to telephone customers connected to the network, the system comprising:
a managed IP network;
a plurality of gateways connected to the managed IP network;
a plurality of telephones connected to the gateways;
a VoIP server connected to the managed IP network;
a SIP server connected to the managed IP network;
each of the gateways having a voice gateway processor wherein the gateway processor converses with the SIP server to establish a telephone call through the managed IP network from a gateway connected to a telephone customer at a source location to a gateway connected to a telephone customer at a destination location.

7. The VoIP telephone network system of claim 6 further comprising:
the gateway processor also converts between analog voice signals and VoIP data packets whereby the VoIP conversion is decoupled from the customer location.

8. The VoIP telephone network system of claim 7 wherein the managed IP network is managed by the telephone company.

9. The VoIP telephone network system of claim 8 wherein:
one or more of the gateways has a DSL modem for providing DSL service to DSL customers of the telephone company.

10. The VoIP telephone network system of claim 7 is located in a telephony edge device at the edge between a telephone line to a telephone customer and a telephony carrier system.

11. The VoIP telephone network system of claim 7 wherein:
each gateway has a battery back-up to power the gateway and the customer phones connected to the gateway through the telephone lines.

12. The VoIP telephone network system of claim 7 wherein the telephone lines are twisted pair lines.

13. A VoIP service method performed in a telephony edge device connected between telephone lines to telephone customers and a telephony carrier system, the VoIP service method providing VoIP service to a telephone customer in a manner decoupled from the telephone devices operating at the customer's location; the VoIP service method comprising:
conversing with a SIP server using session initiation protocol messages to establish a call connection between a call source location and a call destination location; and
coding and decoding between analog voice signals and VoIP data to convert between analog voice signals on the telephone lines and VoIP data on the telephony carrier system whereby VoIP service is provided to a telephone customer without VoIP processing at the customer location.

14. The VoIP service method of claim 13 wherein the telephony carrier system is an internet protocol network.

15. The VoIP service method of claim 13 wherein the telephony carrier system is a telephone company managed internet protocol network.

16. The VoIP service method of claim 13 wherein the telephony edge device has a gateway processor and the act of conversing comprises:
sending and receiving the session initiation protocol messages between the gateway processor and the SIP server whereby the SIP server converses with a softswitch to establish the call connection between the call source location and the call destination location.

17. The VoIP service method of claim 16 wherein the telephony edge device is a DSL aggregate multiplexer.
